(19) United States
(12) Patent Application Publication
(10) Pub. No.: US 2014/0311015 A1
(43) Pub. Date: Oct. 23, 2014

(54) INSECT TRAP HAVING A DESIGN THAT RESEMBLES A BIOLOGICAL DESIGN

(71) Applicant: ChemTica Internacional, Santo Domingo (CR)

(72) Inventor: ALLAN CAMERON OEHLSCHLAGER, Santo Domingo (CR)

(73) Assignee: ChemTica Internacional, Santo Domingo (CR)

(21) Appl. No.: 14/256,659

(22) Filed: Apr. 18, 2014

Related U.S. Application Data
(63) Continuation-in-part of application No. 29/475,310, filed on Dec. 2, 2013.
Application No. 29/475,310 is a continuation-in-part of application No. 29/476,180, filed on Dec. 11, 2013.
(60) Provisional application No. 61/814,794, filed on Apr. 22, 2013.

(51) Int. Cl. A01M 1/02; A01M 1/14

(52) U.S. Cl. CPC A01M 1/023; A01M 1/14
USPC 43/114; 43/107

(57) ABSTRACT

This specification generally relates to a method and device for trapping insects that has at least one opening through which insects may enter an entrapment chamber. The specification generally relates to methods to increase the number of insects captured in a trap by having a design that resembles a biological design, such as a plant or flower. The insect trap may have a flower landing ring, a multicolor surface, and/or a flower design on the bag.

### CROSS REFERENCE TO RELATED APPLICATIONS

This application is a Continuation-in-Part of United States Design applications 29/475,310 (Docket # AO-3), entitled “Insect Trap,” filed Dec. 2, 2013, and 29/476,180 (Docket # AO-5, entitled “Insect Trap,” filed Dec. 11, 2013, both of which were filed by Alan Cameron Oehlschlager, and both of which are incorporated herein by reference; this application also claims priority benefit of U.S. Provisional Patent Application No. 61/814,794 (Docket # AO-4), entitled “Insect Trap Having a Design That Mimics a Biological Design,” filed Apr. 22, 2013, by Alan Cameron Oehlschlager, which is incorporated herein by reference.

### FIELD

This specification generally relates to an insect trap.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Currently available insect traps have many beneficial aspects. However, the effectiveness of past and currently available traps has been less than optimal and may be improved upon. Thus, better and more effective insect traps are needed.

### SUMMARY

Embodiments of an insect trap that has at least one opening through which insects may enter an entrapment chamber are presented. The traps are useful for capturing insects that are attracted to the trap by attractive odors. When the insect encounters the trap the insect lands on the trap and crawls into the trap. Methods are provided to increase the number of insects captured in a trap. The trap may contain an entry port (including an exposed component and a cone component). The entry port and entrapment chamber can have a pleasing visual appearance to insects and to the user. In at least one embodiment, the assembly is easy to use and manufacture. In at least one embodiment the trap includes an anti-spillage feature to protect against spillage during disposal and to protect against creating a negative environmental impact after disposal.

Insect traps and print designs are provided for an insect trap having an entrapment chamber. In at least one embodiment, the insect traps have the addition of a structure that serves as a landing surface surrounding the part of an insect trap through which the insect must enter to be captured. The landing surface resembles a biological design, such as a flower petal. Experimentally, the use of the landing surface was found to increase the number of insects captured.

In at least one embodiment, the insect traps have a biological design, such as multicolored patterns resembling flowers printed on at least the entrapment chamber. Insect traps with a multicolored pattern on at least the entrapment chamber were found to attract more insects than traps with no color or containing colored designs that did not resemble flowers.

In at least one embodiment, insect traps having locking entry ports are provided. Insect traps in which the entry port of the trap may be locked with the top (exposed component) closed are provided that are useful for disposal. In at least one embodiment, the trap may be made of biodegradable materials that allow for less environmental impact than traps made of non-biodegradable materials.

In at least one embodiment, the trap exposed components may be designed to assemble at a single point clip-in mechanism, which simplifies manufacture. The single point clip-in mechanism can allow attachment of the exposed component to the cone component by a single-point clip in. In at least one embodiment, the trap may be designed with a clip mechanism that allows the top exposed component to be locked to the cone component and the entrapment chamber.

Any of the above embodiments may be used alone or together with one another in any combination. Inventions encompassed within this specification may also include embodiments that are only partially mentioned or alluded to, or that are not mentioned or alluded to at all in any way in this brief summary or in the abstract.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a side view of an embodiment of an insect trap closed with a multicolored pattern on the entrapment chamber showing the cone elements within the entrapment chamber in relief

FIG. 2 is a perspective view of an embodiment of the insect trap of FIG. 1 without the entrapment chamber in which the entry port is open.

FIG. 3 is a perspective view of an embodiment of the insect trap of FIG. 1 open that shows how the landing surface can attach to the entry port.

FIG. 4 is a perspective view of an embodiment of the insect trap of FIG. 1 without the entrapment chamber that shows the single point clip-in mechanism for the entry port.

FIGS. 5A1-5A3 and 5B1-5B3 are a variety of perspective views of an embodiment of the entry port for the insect trap of FIG. 1 while the trap is closed (FIGS. 5A1-5A3) and while the trap is open (FIGS. 5B1-5B3).

FIGS. 6A1-6A3 and 6B1-6B3 are a variety of perspective views of an embodiment of the entry port with the landing surface for the insect trap of FIG. 1 while the trap is closed (FIGS. 6A1-6A3) and while the trap is open (FIGS. 6B1-6B3).

FIG. 7 shows the effect of different types of landing surface shapes (e.g., rings) on the capturing of the common housefly (Musca domestica) as compared to one another and to a control trap with no ring.

FIG. 8 provides a figure showing the effect of different types of landing surface shapes (e.g., rings) on the capturing of yellowjackets as compared to one another and to a control trap with no ring.

FIG. 9 shows the effect of different colorings of the top (e.g., the color of the exposed component) on the capturing of the common housefly (Musca domestica) as compared to a control trap with only one color.

FIG. 10 shows the effect of using different colors for the top (e.g., entry port) components on capturing of yellowjackets as compared to a control trap with components of only one color.

FIG. 11 shows the effect of the design and the color of the entrapment chamber (e.g., bag) on capture of the common housefly (Musca domestica) as compared to controls with no color or patterns of color that are different than flowers.

FIG. 12 shows the effect of the design and the color of the entrapment chamber (e.g., bag) on capture of yellowjackets as compared to a control trap with no color.

FIG. 13 shows a flowchart of an embodiment of a method of using the insect trap shown and/or discussed in FIGS. 1-12.

FIG. 14 shows a flowchart of an embodiment of making the trap shown and/or discussed in FIGS. 1-12.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

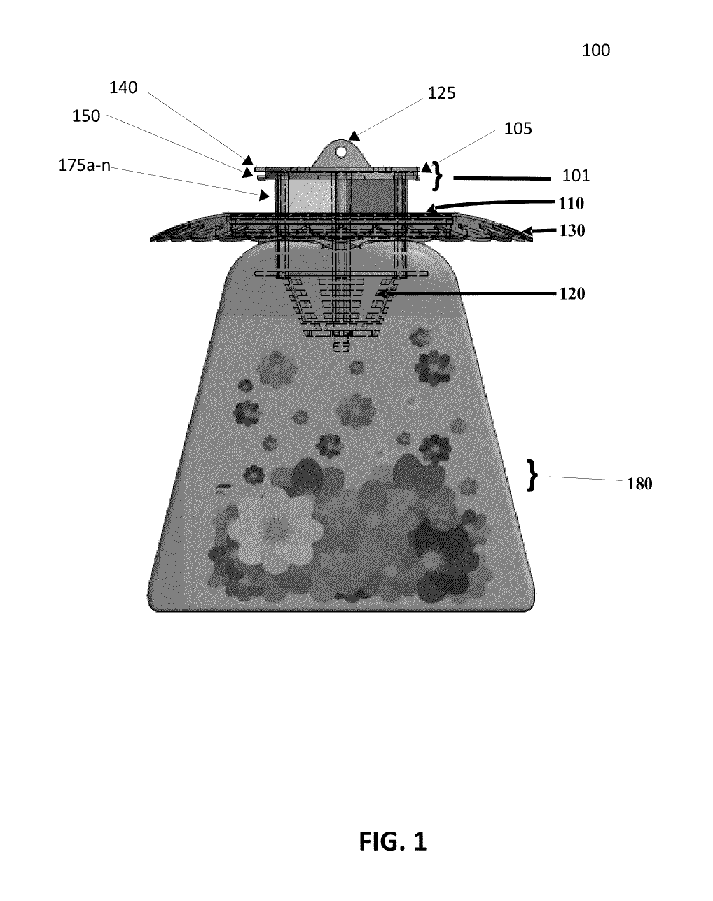

In general, at the beginning of the discussion of each of FIGS. 1-6 is a brief description of each element, which may have no more than the name of each of the elements in the one of FIGS. 1-6 that is being discussed. After the brief description of each element, each element is further discussed. In general, each of FIGS. 1-6 is discussed in numerical order and the elements within FIGS. 1-6 are also usually discussed in numerical order to facilitate easily locating the discussion of a particular element. Nonetheless, there is no one location where all of the information of any element of FIGS. 1-6 is necessarily located. Unique information about any particular element or any other aspect of any of FIGS. 1-6 may be found in, or implied by, any part of the specification.

In various places in discussing the drawings a range of letters, such as a-n . . . are used to refer to individual elements of various series of elements that are the same. In each of these series, the ending letters are integer variables that can be any number. Unless indicated otherwise, the number of elements in each of these series is unrelated to the number of elements in others of these series. Specifically, even though one letter (e.g. “b”) comes earlier in the alphabet than another letter (e.g., “k”), the order of these letters in the alphabet does not mean that the earlier letter represents a smaller number. The value of the earlier letter is unrelated to the later letter, and may represent a value that is greater the same or less than the later letter.

FIG. 1 shows a side view of an embodiment of an insect trap 100 halfway opened, with a multicolored pattern on the entrapment chamber. The insect trap 100 may include exposed component 101, connection ring 110, cone component 120, hanger 125, landing pad 130, top tab 140, bottom tab 150, fins 175a-n, and entrapment chamber (e.g., a bag) 180. In other embodiments the insect trap 100 may not have all of the elements or features listed and/or may have other elements or features instead of or in addition to those listed.

The insect trap 100 is for trapping insects. In an embodiment, the coloring and shape of the components of insect trap 100 are designed to attract insects.

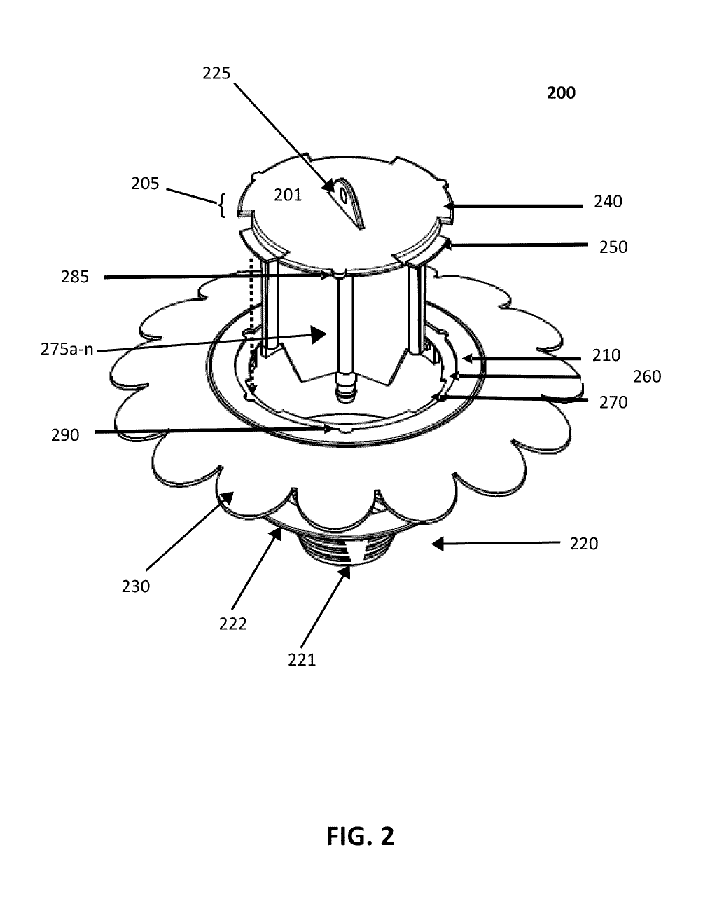

The exposed component 101 is a component of a port for entry of insects into the insect trap and functions to allow entry of one or more insects that are attracted to the insect trap into the entrapment chamber. The exposed component 101 is the component of the entry port that extends outside of the entrapment chamber when trap 100 is deployed (and consequently the entry port is open). Throughout this specification, the “exposed component” may replaced with the terms “top” or “entry port component,” to obtain other embodiments. Throughout this specification, the term entry port maybe replaced with “port,” the “trap entry,” the “entry,” and “entry assembly” to obtain other embodiments. Exposed component 101 will be discussed in more detail with respect to FIG. 2-6. Although exposed component 101 is the top of the entry port in FIG. 1, the entry port may also be located at other locations on the entrapment, in which case exposed component 101 is no longer the top of the entry port, but the outer component or the component exposed to the outside. However, in short, exposed component 101 can be configured to be closable so that any insects that have been trapped can be closed and locked into the entrapment chamber. Exposed component 101 can be configured to be more attractive to insects and/or to be less unattractive to insects. Methods of making exposed component 101 more attractive are discussed in the detailed description and examples, but may include a biological design, such as making the exposed component a more natural color (the color of nature, flowers, leaves, etc.) or adding an attractant to the entry port (see the section entitled “the attractant” for more information).

Entry port lid 105 may include a series of tabs, inserts, notches, flanges and/or openings that allow the closing of the exposed component 101. Entry port lid 105 forms the lid of the port for entry of insects into insect trap 100. The entry port lid 105 in FIG. 1 shows a top tab and bottom tab which are explained in more detail with reference to FIG. 2. Entry port lid 105 may be referred to as the “top of the exposed component” or “top of the entry port” herein.

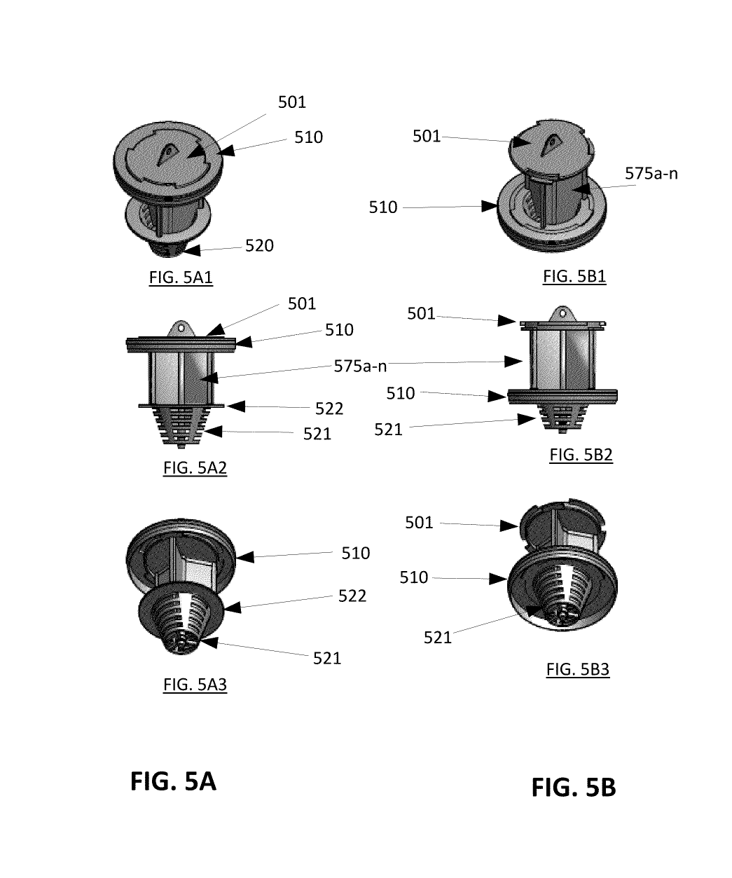

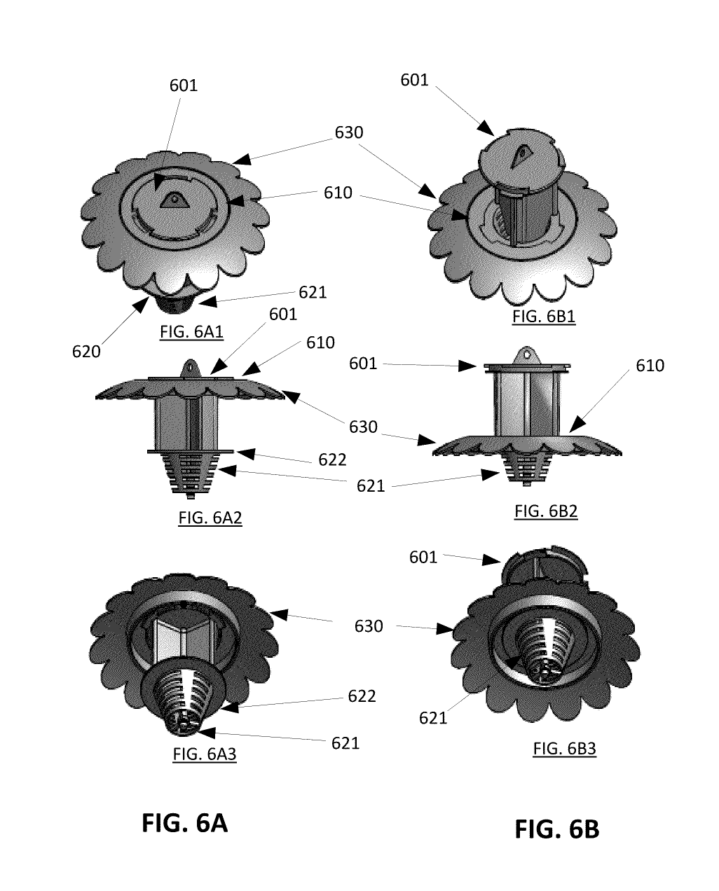

Connection ring 110 connects the landing pad 130 to the exposed component 101 and/or the entrapment chamber 180. The connection ring 110 may be fabricated to connect the entrapment chamber 180 to the landing pad 130 and/or exposed component 101. The connection ring 110 may be composed of one or more layered rings with tabs and inserts that allow connection to the exposed component 101 and/or the entrapment chamber 180. The connection ring 110 may be composed of one or more layered rings having tabs, inserts, notches, and openings that allow the closing of the exposed component 101. When closed, insects (alive or dead) cannot enter and will not fall out of the entrapment chamber. The closing mechanism locks the entry port to the rest of the trap so that during removal and disposal, spillage of the contents of the entrapment chamber are avoided (FIGS. 5 and 6 provide more detailed information on the opening and closing of the port).

Cone component 120 is a receptacle containing openings that funnel insects into the entrapment chamber 180. The combination of cone component and exposed component 101 for the entry port of the entrapment chamber 180. Cone component 120 can be configured in any shape that allows insects entry into the entrapment chamber 180. Although the cone component 120 is shown as a cone shape with slatted holes in FIG. 1, the cone component 120 can be any shape usable with the rest of the entry port and/or the entrapment chamber 180 (square, rectangular, pyramidal, v-shaped, round, etc.), so long as cone component 120 has an opening of a shape that guides the insect through cone component 120 to a smaller exit that exits into the entrapment chamber 180. Cone component 120 contains one or more holes that allow movement of the insects from the exposed component 101 into the entrapment chamber 180. While the holes are shown as slits (horizontal rectangles) between slats in the cone-shaped cone component 120 in FIG. 1, the holes can be of any configuration that allows entry into the entrapment chamber 180 (round, square, vertical shapes, etc.). In an embodiment, the slits may be absent or too small for the insect to pass through and the insect may enter entrapment chamber 180 through a hole at the bottom of cone component 120.

Hanger 125 is any device that allows insect trap 100 to be hung in, or affixed to, an environment of choice. Hanger 125 may be any hanging device, such as a hook. While shown in FIG. 1 as a tab with a hole, hanger 125 can be of any configuration that allows fixation of a wire, nail, screw, string, rope, or other attachment method. In an embodiment, the insect trap 100 may be attached in a natural area (e.g., to a tree), in a home environment (e.g., to a house or garden structure), or in a public area (e.g., to a structure, fence, etc.). Hanger 125 may be configured in such a way that insect trap 100 can be set in one or more of those environments.

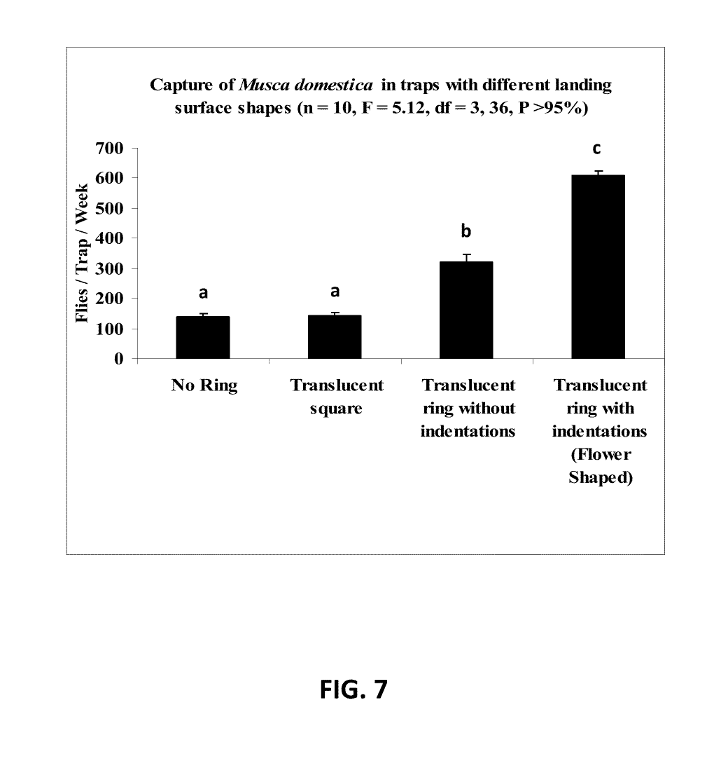

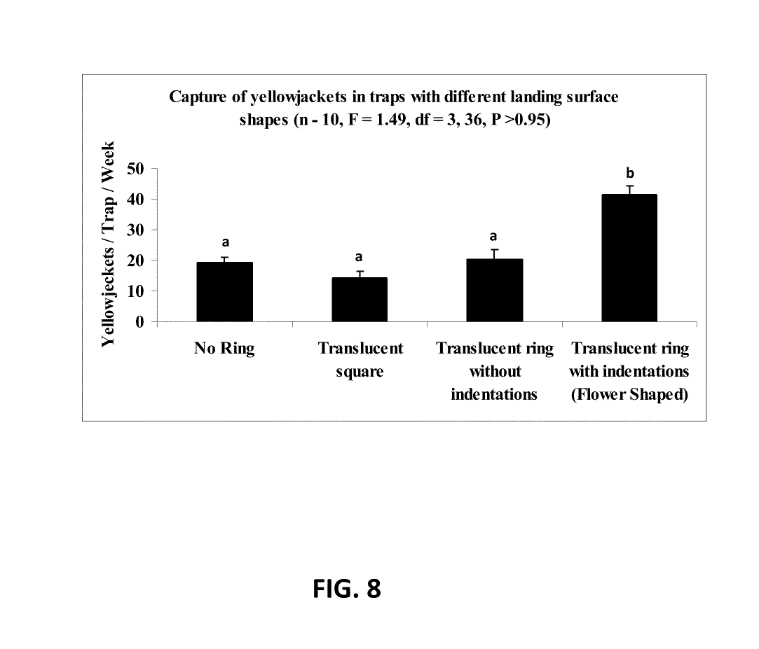

Landing pad 130 is a landing surface surrounding the exposed component 101. In an embodiment, landing pad130 is a ring having a shape that resembles a flower. Throughout this specification, the word “pad” in the phrase “landing pad” may be replaced with the word ring or surface to obtain other embodiments. The insect trap 100 can provides a landing surface that resembles a biological design and/or an entrapment chamber (e.g., bag) that resembles a biological design. The landing pad 130 serves as a landing surface surrounding the part of an insect trap through which the insect must enter to be captured. While the landing pad 130 is shown as a complete ring around the insect trap, the landing pad 130 can be a partial ring (e.g., only wraps 99% or less of the way around exposed component 101, including but not limited to, 98%, 97%, 96%, 95%, 94%, 93%, 92%, 91%, 90%, 85%, 80%, 70%, 65%, 60%, 55%, 50%, 45%, 40%, 35%, 30%, and 25% of the way around exposed component 101). The landing surface may resemble a biological design, such as a flower petal. The use of a landing surface having a biological design was found to increase the number of insects captured (the effect of the landing surface will be discussed further in conjunction with FIGS. 7-8). The landing pad 130 can be attached to any part of the insect trap 100, including the entrapment chamber 180, the connection ring 110, the exposed component 101, or the cone component 120. The landing pad 130 may move with the lid of exposed component 101 (and/or be part of the lid) with respect to the entrapment chamber 180 to create a closed or open condition for the trap.

With reference to FIG. 1, the landing pad 130 surrounds the exposed component (the top component 101). The landing pad 130 resembles a biological design. In one embodiment, resembling a biological design means that the landing pad may resemble a flower (e.g., petals) with an irregular exterior edge. Any type of irregular edge can be envisioned to work as there are a wide variety of flower shapes and structures in nature. In contrast, a regular edge, for example would include a circle, a square, or a rectangle. The specific design of landing pad 130 of resembling a flower at landing pad 130's exterior edge makes the trap more attractive to insects and improves the visual appearance of the trap to users (see the Example section for more information).

Top tab 140 is a tab, flange, or lip horizontally overhanging the top of the exposed component 101. Top tab 140 allows the opening and closing of the exposed component 101 to allow insects into the entrapment chamber 180 (when entrapment chamber 180 is open) or to keep insects inside the entrapment chamber 180 (when entrapment chamber 180 is closed). Top tab 140 may be inserted into a recess in the connection ring 110 (see FIG. 2). Inserting top tab 140 into a recess closes the entry port 101. One embodiment of the method of closing the exposed component 101 will be discussed in more detail with reference to FIG. 2. However, closing the entry port may include sliding top tab 140 into a recess and rotation of the exposed component 101.

Bottom tab 150 is one or more tabs, flanges, or lips horizontally overhanging the top of the exposed component 101. Bottom tab 150 allows the opening and closing of the exposed component 101 so that insects may enter into the entrapment chamber 180 (when entrapment chamber 101 is open) preventing insects from leaving the entrapment chamber for removal (when entrapment chamber 101 is closed) and replacement of the entrapment chamber 180. Bottom tab 150 inserts into a notch (see notch 270 in FIG. 2) in the connection ring 110 closing the entry port. One embodiment of the method of closing the entry port will be discussed in more detail with reference to FIG. 2.

In other embodiment, top tab 140 and bottom tab 150 may have other shapes, as long as top tab 140 and bottom tab 150 are configured to attach to or fit within another shape or recess on the connection ring 110 or cone component 120 holding entry port 101 closed.

Fins 175a-n form the middle part of the exposed component 101. In this specification, anywhere the term fin appears the term flange or baffle may be substituted to obtain another embodiment. Fins 175a-n support lid 105, so that lid 105 is less likely to wobble that were lid 105 mounted on the end of a rod. In an embodiment, towards the bottom of fins 174a-n, the sides of fins 174a-n are beveled (or slanted) so as to rest on the sides of cone component 120 when exposed component 101 is attached to cone component 120. In an embodiment, at the very bottom of fins 174a-n are flat. The fins 175a-n provide an opening for insects to pass from the entry port to the entrapment chamber. The openings that the insects pass through are between the fins 175a-n. While the fins 175 a-n are shaped like fins in FIG. 1, the fins 175a-n can be shaped in any way that provides an opening and allows enough space for the insects to move into the cone component 120, while also supporting the top lid of exposed component 101. The fins 175a-n can be shaped in any way that also allows movement of the top of the exposed component onto the connection ring 110 (for closure). For example, fins 175a-n could be rounded, squared, beveled, etc. Alternatively, the middle portion of the exposed component 101 could be a recessed round shape. The shape of the middle portion can be varied as long as the top portion of entry port 101, contains tabs available for attaching to the connection ring 110.

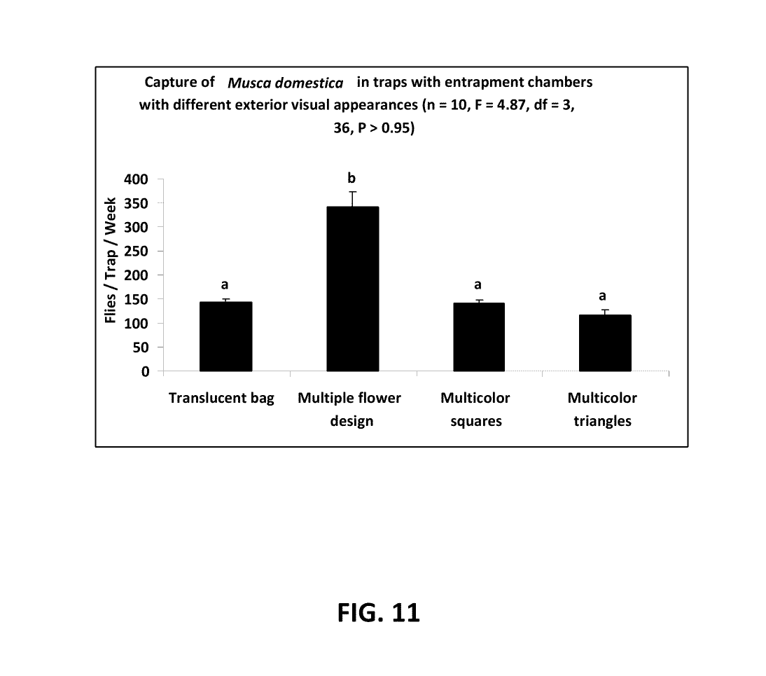

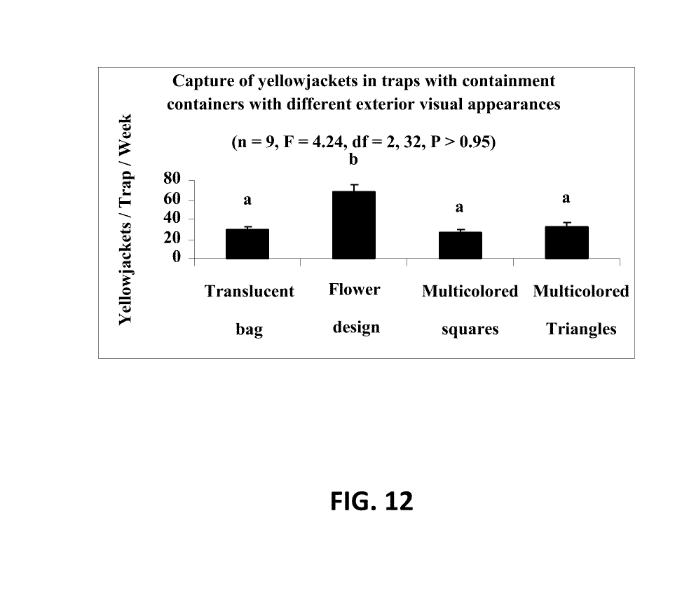

Entrapment chamber (e.g., bag) 180 is a chamber or bag that contains the trapped insects. The entrapment chamber 180 can be configured in any shape that allows for the entrapment of one or more insects. In at least one embodiment, the entrapment chamber 180 is a bag. The bag can be round, square, rectangular, or any shape. The entrapment chamber can resemble a biological design (e.g., flowers). For example, when insect traps were fabricated to contain multicolored patterns resembling flowers printed on the entrapment chamber (see Examples), the insect traps were found to attract more insects than traps with no color or containing colored designs that did not resemble flowers (the effect of the entrapment chamber will be discussed further in conjunction with FIGS. 11-12). In an embodiment entrapment chamber 180 has a wedge shape. The entrapment chamber 180 may include any type of attractant (see section entitled “the attractant” for more information). Optionally, the entrapment chamber 180 may include any type of insect-retaining adhesive (see section entitled “Insect-retaining adhesive” for more information). Entrapment chamber can be composed of a material that retains the insects inside the entrapment chamber. Entrapment chamber 180 can be composed of a thin paper-like material, a plastic, a cotton, and/or a natural fiber.

In at least one embodiment, the exposed component 101, the cone component 120, the landing pad 130, and/or the entrapment chamber 180 may be fabricated from biodegradable plastic. Since traps of this type that are attached to a rigid entrapment chamber are often damaged and discarded, the fabrication of these traps from biodegradable plastic is a benefit to the environment. In at least one embodiment, traps of the design described herein that contain a flexible entrapment chamber are designed for single use and are discarded after a single use. For these disposable traps, fabrication from biodegradable plastic that degrades naturally to non-toxic components in a time frame consistent with its disposal method may be desirable. In an embodiment, the traps used in the examples in FIGS. 7-13 were fabricated from plastic that meets the current ASTM D6400 standard. In an embodiment, any plastic that has the property of thermal deformation or is able to be molded by injection molding and meets the ASTM D6400 standard is suitable for fabrication of the trap.

In at least one embodiment, the exposed component 101, the cone component 120, the landing pad 130, and the connection ring 110 are composed of a material that is reusable and may also be cleanable and/or sterilizable. In at least one embodiment, the entrapment chamber 180 is removable and a new entrapment chamber 180 can be added to the (cleaned and/or sterilized) reusable insect trap.

FIG. 2 is a perspective view of an embodiment of the insect trap of FIG. 1 without the entrapment chamber. In FIG. 2, the entry port is open. In FIG. 2 features of the top component (entry port) and connection ring are shown. The insect trap 200 may include exposed component 201, entry port lid 205, connection ring 210, cone component 220, cone receptacle 221, cone rim 222, hanger 225, landing pad 230, top tab 240, bottom tab 250, recessed flange 260, notches 270, fins 275a-n, entrapment chamber (e.g., a bag) 280, and indentations 290. In other embodiments the insect trap 200 may not have all of the elements or features listed and/or may have other elements or features instead of or in addition to those listed.

For example, the landing pad 230 can be attached to the exposed component 201, the connection ring 210, the entrapment chamber 280, or the cone component 220.

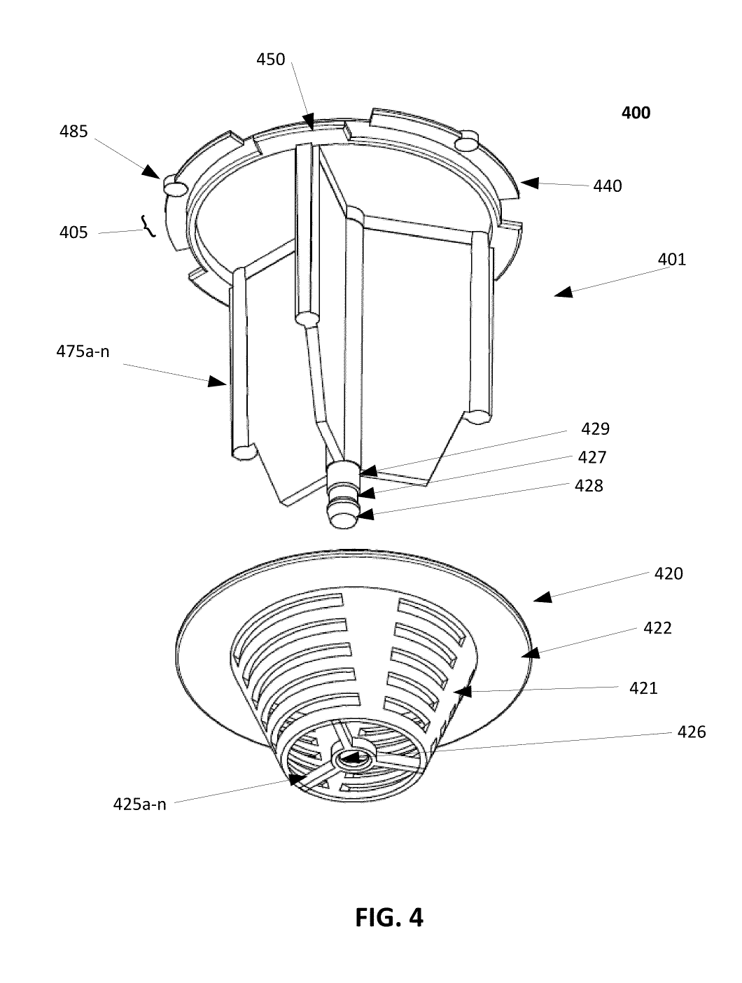

The exposed component 201 is a circular component with an entry port lid 205 (a top section), a middle section (fins 275a-n) and an opening for insects to enter the insect trap. The exposed component 201 attaches to a cone component 220 (see FIG. 4 for a clearer view of the two components). The top of the exposed component 201 has a lid area 205 (to which the fixation device is attached) with a thickness containing a number of tabs (240 and 250). The exposed component 201 also has a middle area with fins 275a-n. The entry port 201 can be locked closed using the tabs so that insects cannot enter or leave the entrapment chamber. Insect traps in which the entry port of the trap may be closed or locked are useful for disposal.

Entry port lid 205 is an embodiment of entry port lid 105, which has been discussed with reference to FIG. 1.

Connection ring 210 is a ring that attaches to exposed component 201 that can move up and down in relation to exposed component 201. Connection ring 210 provides a number of recesses, notches and indentations that can be used to insert the tabs in the top part of the exposed component 201 to close and/or lock the exposed component 201. For example, connection ring 210 may include recessed flange 260, notches 270, and indentations 290. Connection ring 210 may also be used to attach a landing pad 230.

Cone component 220 is a receptacle that allows insects to enter the entrapment chamber 180. In FIG. 2, cone component is detached from exposed component 201. Cone component 220 can be attached to the entry port 201 (see FIG. 4). During normal use of insect trap 200, cone component 220 is attached to exposed component 201. Cone component 220 and exposed component 201 slide up and down together within connection ring 210 to open and close insect trap 200. Cone component 220 includes the cone receptacle 221 and the cone rim 222. See FIGS. 1, 3 and 4 for a discussion of the configuration of cone component 220 in more detail.

Cone receptacle 221 is an opening in the cone component 220 that provides access for insects to enter the entrapment chamber (see 180 in FIG. 1) and/or can funnel the insects into the entrapment chamber.

Cone rim 222 clips into a tab, which stabilizes the external component 201 and the connection ring 210 once the trap 100 is opened.

Hanger 225 is an embodiment of hanger 125, which was discussed in conjunction with reference to FIG. 1.

Landing pad 230 provides a surface for insects to land and enter the insect trap. The insect trap of FIG. 2 contains a flower-petal like landing pad (see also FIG. 1). Landing pad 230 is an embodiment of landing pad 230, which was discussed in conjunction with reference to FIG. 1.

Top tab 240 is a tab on the top of the exposed component 201 that holds the entry port 201 closed. Top tab 240 extends horizontally from the top surface of the exposed component 201. Top tab 240 is an embodiment of top tab 140 (see also FIG. 1 for a discussion of the top tab 140).

Bottom tab 250 is a tab on the top of the exposed component 201, just below top tab 240, that can be used to close the entry port 201. Bottom tab 250 extends horizontally from the bottom surface of the top of the entry port 201. Bottom tab 250 is an embodiment of bottom tab 150 (see also FIG. 1 for a discussion of the bottom tab 150).

Recessed flange 260 is a bottom lip providing a recess within the connection ring 210 horizontal to the connection ring 210 and the top of the exposed component 201. Recessed flange 260 creates a recess for the top tab 240 to insert into when closing the exposed component 201 and/or for the tabs to rotate into. One embodiment of the method of closing the exposed component 201 using the recessed flange 260 will be discussed in more detail below with reference to FIG. 2.

Notches 270 are cut outs within recessed rim 260, which receive bottom tab 250. In an embodiment, notches 270 are shaped to receive the bottom tab 250. Notches 270 may have a complementary shape to bottom tab 250. When the top of the exposed component 201 is moved down onto the connection ring 210, bottom tab 250 (of the exposed component 201) inserts into notch 270 closing the entry port. The exposed component 201 can be twisted within the recess in the connection ring 210, so that tab 250 is covered by recessed flange 260, which locks the entry port closed.

Fins 275a-n form the middle part of the exposed component 201. Fins 275a-n are an embodiment of fins 175a-n (see FIG. 1).

Circular tab 285 is a tab that may be included on the top tab 240 to aid correct insertion, closure and/or locking Circular tab 285 on the top of the exposed component 201 inserts into indentations 290 on the connection ring 210. While circular tab 285 is not necessary for closure of the entry port, circular tab 285 can function to make the closure and/or locking of the entry port more secure.

Indentations 290 are notches in a flange on connection ring 210 shaped to accommodate the circular tab 285 on the connection ring 210 to allow insertion of the circular tab 285 and bottom tab 250 (on the exposed component 201) into a recess in the connection ring 210. Once inserted, the exposed component 201 can be turned sliding circular tab 285 under connection ring 210 to lock the entry port closed.

As shown in FIG. 2, the exposed component 201 is fabricated to be pushed down toward the connection ring 210 to close the entry port 201. The top of exposed component 201 is fabricated with top tabs 240 near the top surface and bottom tabs 250 that are fabricated to be placed horizontally below the top tabs 140 on the exposed component 201. The bottom tabs 250 is fabricated to fit into a recessed flange 260 fabricated in the connection ring component 210. The recessed flange 260 is fabricated so that when the connection ring 210 and the exposed component 201 are pushed together in the direction of the dashed arrow, the upper surfaces of the connection ring 210 and the exposed component 201 are parallel. Top tabs 240 of the exposed component 201 are constructed in a manner that allows the bottom surfaces of top tabs 240 to slide against the upper surface of the connection ring 210 when the connection ring 210 is positioned so that the top surfaces of exposed component 201 and the connection ring 210 are parallel. Bottom tab 250 of exposed component 201 is constructed in a manner that allows the upper surfaces of bottom tabs 250 to slide against the lower surface of the connection ring 210 when the connection ring 210 is positioned so that the top surfaces of exposed component 201 and the connection ring 210 are parallel. The distance between the lower surface of top tabs 240 and the upper surface of bottom tabs 250 are fabricated to allow exposed component 201 to rotate with respect to connection ring 210 once exposed component 201 and the connection ring 210 are pushed together and the upper surfaces of exposed component 201 and connection ring 210 are parallel. Recessed flange 260 of connection ring 210 is further fabricated with one or more indentations 270 that allow bottom tabs 250 to pass to a position in which the upper surface of bottom tabs 250 are able to slide with respect to the lower surface of the connection ring 210. Exposed component 201 is shown with three bottom tabs 250 but the number of top tabs 240 and bottom tabs 250 may be different. In at least one embodiment, there are one or more top tabs 240 and bottom tabs 250, including two, three, four, five or more tabs.

In at least one embodiment, further positioning of exposed component 201 and connection ring 210 is achieved with additional tabs (circular tabs 285) and indentations 290. Pushing exposed component 201 downwards to a position in which the top surface of exposed component 201 and connection ring 210 are parallel causes one or more additional tabs 285 fabricated on the outer edges of tabs 250 of exposed component 201 to be positioned into one or more corresponding indentations 290 in the side of recessed flange 260 in connection ring 210. In the embodiment of exposed component 201 of FIG. 2 there are three circular tabs 285 and in connection ring 210 there are six indentations in the sides of recessed flange 260 of connection ring 210 to receive the tabs 285. Once exposed component 201 and connection ring 210 are in a position in which the top surface of tab 250 is below the lower surface of top connection ring 210, then the upper surfaces of exposed components 201 and connection ring 210 will be parallel. Assuming that there are three sets of tabs 285 and indentations 290 when exposed component 201 and connection ring 210 are positioned in parallel, rotating exposed component 201 with respect to connection ring 210 by approximately 60 degrees, or between about 5 or 10 degrees and a little less than 60 degrees, in either direction will remove tabs 285 from the indentations 290, so that tabs 285 are under connection ring 260 in which indentations 290 are located, into which the tabs 285 were required to be located during the joining of exposed component 201 and connection ring 210 (when exposed component 201 and connection ring 210 are joined, place tabs 285 in indentations 290 are adjacent to the indentations that initially received the tabs 285 during joining) Rotating exposed component 201 by approximately 60 degrees or between about 5 or 10 degrees and a little less than 60 degrees, will move tab 250 under recessed flange 260 and cause locking of exposed component 201 and connection ring 210 in a closed position. The reverse rotation will allow tab 250 to be positioned directly under indentation 270, and thereby allow exposed component 201 to move vertically away from connection ring 210.

Exposed component 201 is shown with three circular tabs 285. Consequently, connection ring 210 is shown with six indentations to receive the three tabs 285 on exposed component 201. However, if exposed component 201 contains a different number of tabs 285, connection ring 210 would contain an appropriate number of indentations 290 to receive the tabs 285. The indentations 290 are positioned so that bottom tabs 250 on exposed component 201 may be positioned to allow movement of exposed component 201 with respect to connection ring 210 to the upward and open position and to achieve a locked and closed orientation between exposed component 201 and connection ring 210.

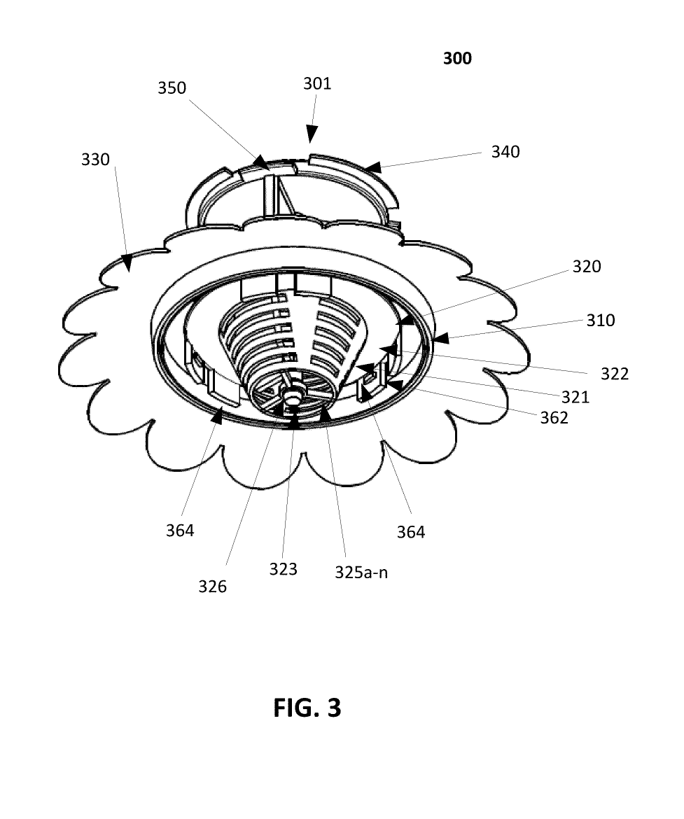

FIG. 3 is a perspective view of an embodiment of the insect trap of FIG. 1 that shows how the landing surface attaches to the connection ring 310. The insect trap 300 is shown open. The insect trap 300 may include exposed component 301, connection ring 310, cone component 320, cone receptacle 321, cone rim 322, tapered portion 323, struts 325a-n, ring 326, landing pad 330, top tab 340, bottom tab 350, top connection tab 362, bottom connection tab 364, and fins 375a-n. In other embodiments insect trap 300 may not have all of the elements or features listed and/or may have other elements or features instead of or in addition to those listed.

The insect trap of FIG. 3 provides an entry port that can be locked closed so that insects cannot enter or leave the entrapment chamber. The insect trap in FIGS. 5A and 6A is closed as compared to the insect trap of FIG. 2. Insect traps in which the entry port of the trap may be locked with the top closed are useful for disposal. The insect trap of FIG. 2 also contains a flower-petal like landing pad (see also FIG. 1).

Exposed component 301 is an embodiment of exposed component 101 and 201, which have been discussed with reference to FIGS. 1 and 2, respectively.

Connection ring 310 was discussed with reference to FIGS. 1 and 2 as connection ring 110 and 210. However, the connection ring 310 shown in FIG. 3 also shows how the landing surface 330 can attach to the connection ring 310.

Cone component 320 was discussed with reference to FIGS. 1 and 2 as cone component 120 and 220. As discussed in FIGS. 1 and 2, cone component 320 includes cone receptacle 321 and cone rim 322. However, FIG. 3 shows further details of the cone component 320, including the struts 325a-n and the ring 326.

Cone receptacle 321 was discussed with reference to FIG. 2 as cone receptacle 221. However, FIG. 3 shows that cone receptacle also contains struts 325a-n and ring 326 in the cone component 320. The ring 326 attaches to the exposed component 301 (see FIG. 4).

Cone rim 322 was discussed with reference to FIG. 2 as cone rim 222. However, FIG. 3 shows that cone rim 322 fits tightly into the connection ring 310 to act to stabilized the connection between the cone 320 and the connection ring 310 as discussed below as a barrier.

Struts 325a-n are bars radiating outward from the ring 326 of the cone component 320 to attach to the cone receptacle 321. The struts 325a-n act to hold the ring 326 onto the cone component 320.

Ring 326 is attached to the cone component 320. The ring 326 is configured to attach the cone component 320 to the exposed component 301. Refer to FIG. 4 for more information about the attachment process.

Tapered portion 323 is configured to securely insert into the ring 326 of the cone component 320. The tapered portion 323 is part of the exposed component 301 and functions to attach the exposed component 301 to the cone component 320. The attachment is discussed in more detail in FIG. 4.

Landing pad 330 has been discussed with reference to FIGS. 1 and 2 as landing pad 130 and 230, respectively.

Top tab 340 has been discussed with reference to FIGS. 1 and 2 as top tab 140 and 240, respectively.

Bottom tab 350 has been discussed with reference to FIGS. 1 and 2 as bottom tab 150 and 250, respectively.

Top connection tab 362 is formed on the connection ring 310 and acts to attach the connection ring 310 to the cone component 320. Top connection tab 362 is fabricated to allow top connection tab 362 to be moved laterally to a perpendicular position. Cone rim 322 clips into a tab 362, which stabilizes the external component 301, and the connection ring 310 once the trap 100 is opened.

Bottom connection tab 364 is formed on the connection ring 310 and acts to attach the connection ring 310 to the cone component 320. Bottom connection tab 364 is fabricated to allow bottom connection tab 364 to be moved laterally to a perpendicular position.

Fins 375a-n are embodiments of fins 275a-n and 175a-n, which have been discussed with reference to FIGS. 1 and 2, respectively.

With further reference to FIG. 3, cone component 320 is fabricated with a rim 322 extending from cone component 320's dimension of largest diameter. Connection ring 310 is fabricated with top connection tabs 362 extending downwards at a location that allows the outer dimension of the rim 322 of cone component 320 to slide against the internal surface of top connection tabs 362 to a position in which the upper surface of rim 322 on cone component 320 touches the lower surface of connection ring component 310. Referring to the internally facing sides of top connection tabs 362, there are additionally fabricated bottom connection tabs 364 that, as a result of the flexibility of top connection tabs 362, allow rim 322 to pass upward below connection ring 310 and recessed rim 360, leaving room for tabs 350 to slide between recessed flange 360 and rim 322. Bottom connection tabs 364 are positioned and constructed so that once rim 322 touches connection ring component 310, bottom connection tabs 364 move toward each other and the upper sides of bottom connection tabs 364 touch the lower sides of the outer portion of rim 322 to lock rim 322 against connection ring component 310. As a result, connection ring component 310 and cone component 320 are locked firmly against each other and do not disengage during windy periods. As result of connection ring component 310 and cone component 320 locking firmly against each other, connection ring component 310 and cone component 320 are more tightly held together than gravity would connect the cone to the part of the trap containing the entrapment chamber.

Alternatively or additionally, the landing surface may attach to the portion of the entry port attached to the entrapment chamber.

FIG. 4 is a perspective view of an embodiment of the insect trap 100 of FIG. 1 that shows the single point clip-in mechanism for the entry port (top component). The insect trap 400 is shown without the entrapment chamber. The insect trap 400 may include exposed component 401, entry port lid 401, cone component 420, cone receptacle 421, cone receptacle 421, the cone rim 422, struts 425a-n, ring 426, groove 427, tapered portion 428, rod 429, landing pad 430, top tab 440, bottom tab 450, fins 475a-n, and circular tab 485. In other embodiments insect trap 400 may not have all of the elements or features listed and/or may have other elements or features instead of or in addition to those listed.

The insect trap in FIG. 4 does not show a connection ring (see 310 in FIG. 3) or a landing pad (see 330 in FIG. 3). The insect trap in FIG. 4 provides entry port and cone components that may be designed to assemble at a single point clip-in mechanism. The traps that assemble at a single point clip-in mechanism simplify manufacture of the insect traps.

Exposed component 401 is an embodiment of exposed component 101, 201 and 301, which have been discussed with reference to FIGS. 1-3, respectively. However, FIG. 4 shows a more detailed view with the entry port removed from the landing pad, connection ring, and entrapment chamber. FIG. 4 shows details of the fins 475a-n. FIG. 4 shows details of the bottom of exposed component 401, groove 427, tapered portion 428, and rod 429 that is used to attach the exposed component 401 to the cone component 420.

Entry port lid 405 is an embodiment of entry port lids 105 and 205, which have been discussed with reference to FIGS. 1 and 2.

Cone component 420 includes the cone receptacle 421, the cone rim 422, the struts 425 a-n and the ring 426. Cone component 420 is an embodiment of cone component 120, 220 and 320, which have been discussed with reference to FIGS. 1-3, respectively. FIG. 4 shows the details of how cone component 420 attaches to exposed component 401, via the ring 426.

Cone receptacle 421 is an embodiment of cone receptacle 221 and 321, which have been discussed with reference to FIGS. 2 and 3, respectively.

Struts 425a-n are embodiment of struts 225a-n and 325a-n, which have been discussed with reference to FIGS. 2 and 3, respectively.

Groove 427 allows secure attachment of the ring 426 on the rod of the exposed component 401. The diameter of groove 427 is close to, but slightly less than the inner diameter of the ring 426, and significantly less than the tapered portion 428 and/or the rod 429.

Tapered portion 428 of the rod on the exposed component 401 allows movement into the ring 426 portion of the cone component 420. Tapered portion is tapered such that when the ring 426 is sliding onto the tapered portion, the ring 426 moves from a smaller diameter to a larger diameter (until the ring 426 encounters the groove 427). In an embodiment, tapered portion 428 may be made of a resilient material, so that tapered portion 428 is temporarily compressed slightly by ring 426 as ring 426 slides over tapered portion 428. Afterwards, tapered portion 428 returns to the original shape that tapered portion 428 had prior to being inserted into ring 426.

Rod 429 is a rod extending from the exposed component 401 to attach to the cone component 420. Rod includes a small dimension portion (groove 427) and a tapered portion (tapered portion 428) to allow secure attachment to the cone component 420. However, rod 429 can be configured in any way that allows attachment to the ring 426 of the cone component. In at least one embodiment, the attachment is secure and the cone component 420 will not slip off of the rod 429.

Ring 426 is an embodiment of ring 326, which has been discussed with reference to FIG. 3. The ring 426 is part of the cone component 320 and functions to attach the cone component 320 to the exposed component 401. Ring 426 may be made of a resilient material that stretches as tapered portion 428 is inserted through ring 426. One or both of ring 426 and tapered portion 428 may deform slightly as tapered portion 428 is inserted through ring 426, and then returns to their former shape after ring 426 is in groove 427. After being placed in groove 427, ring 426 returns to the original shape that ring 426 had prior to rod 429 being inserted into ring 426.

Top tab 440 and bottom tab 450 are embodiments of top tabs 240 and 340 and bottom tabs 250 and 350, respectively, which have been discussed in reference to FIGS. 2 and 3.

Fins 475a-n are embodiments of fins 275a-n and 375a-n, which have been discussed with reference to FIGS. 2 and 3.

Circular tab 485 are embodiments of circular tab 285, which has been discussed with reference to FIG. 2.

In at least one embodiment, a single point joining of exposed component 401 and cone component 420 may be achieved by use of groove 427, tapered portion 428, and rod 429 extending from the exposed component 401 and an orifice (a ring 426) in cone component 420 that attaches to the groove 427, tapered portion 428, and rod 429.

With further reference to FIG. 4, the exposed component 401 and the cone component 420 may be connected by a single point of connection between the exposed component 401 and the cone component 420. The single point clip-in mechanism eliminates a rotational orientation step in the joining of the exposed component 401 and the cone component 420. Exposed component 401 is shown fabricated with a single rod 429 extending from the center of its multiple fins 475a-n. The rod 429 is fabricated to have a tapered end 428. Then, moving upwards, the rod 429 has a dimension that is smaller than the interior dimension of a ring 426 (a groove 427). The ring 426 is fabricated in the center of the small end of the cone component 420. The ring 426 is attached to the cone component 420 by one or more struts 425a-n. The dimension of the rod 429 is fabricated to be slightly smaller than the interior dimension of the ring 426 in the center of the cone component 420. To achieve a tight connection between the exposed component 401 and the cone component 420, the groove 427 of the rod 429 may be only of a length to accommodate the vertical thickness of the ring 426 on the cone component 420.

Exposed component 401 and connection ring 420 are first oriented with respect to each other so that the ring 426 fabricated in the center of the small dimension of cone component 422 is located away from rod 429 extending from the cone component 420. Exposed component 401 and cone component 420 are next joined by moving the tapered end 428 of rod 429 onto exposed component 401 by passing the tapered end 428 into the ring 426. When ring 426 fully contacts the groove 427 of rod 429, then there will be resistance to moving the ring 426 in either direction along rod 429, because in both directions the dimension of rod 429 is larger than the center opening in the ring 426. By having both dimensions of the rod 429 larger than the center opening in the ring 426, exposed component 401 and cone component 420 are joined by a single point of contact between the groove 427 and the ring 426 and no rotational orientation between exposed component 410 and cone component 420 is needed to effect the joining In at least one embodiment, the point of juncture of exposed component 401 and cone component 420 may involve the juncture point of cone component 420 being at or near the large dimension of the cone of cone component 420 or equally any location along the cone between the small dimension of the cone and the large dimension of the cone.

FIGS. 5A-B are a variety of perspective views of an embodiment of the entry port for the insect trap of FIG. 1 closed (FIG. 5A) and open (FIG. 5B).

FIGS. 5A1-5A3 and 5B1-5B3 show a variety of perspective views of an embodiment of the entry port for the insect trap of FIG. 1. FIG. 5A1-5A3 shows the entry port closed and FIG. 5B1-5B3 shows the entry port open. The entry port of the insect trap 500 may include exposed component 501, connection ring 510, cone component 520, cone receptacle 521, cone rim 522, and fins 575a-n. In other embodiments 500 may not have all of the elements or features listed and/or may have other elements or features instead of or in addition to those listed.

The insect trap 500 of FIGS. 5A and 5B may include all of the features discussed in FIGS. 1-4. In other embodiments the insect trap 500 may not have all of the elements or features listed and/or may have other elements or features instead of or in addition to those listed.

Exposed component 501, connection ring 510, cone component 520, cone receptacle 521, cone rim 522, and fins 575a-n are embodiments of exposed component 301, connection ring 310, cone component 320, cone receptacle 321, cone rim 322, and fins 375a-n, which have been discussed with reference to FIG. 3. Other aspects of each part of the insect trap have been discussed in conjunction with prior figures.

FIGS. 5A and 5B do not show the entrapment chamber (e.g., bag) in order to show the configuration of the exposed component 501 and the cone component 520 from different angles. In FIGS. 5A1-5A3, the top and cone components are shown closed. The closed configuration closes the entry port. When closed, insects (alive or dead) cannot enter and will not fall out of the entrapment chamber. The mechanism locks the entry port 501 to the rest of the trap (the connection ring 510 and/or cone component 520) so that during removal and disposal, spillage of the contents of the entrapment chamber are avoided. Avoiding spillage may be desirable when the trap is used for pests that carry dangerous bacteria such as house flies or cause harmful wounds such as yellowjackets. Locking the top entry components to the remaining trap components in the closed position lowers the risk of escape of bacteria laden contents or injurious insects such as yellowjackets, which may be advantageous. Note that when the entrapment chamber is closed, the connection ring 510 is at the top of the exposed component 501 away from the cone component 520.

In FIGS. 5B1-5B3, the exposed component 501 and cone components 520 are shown open. The open configuration allows for the entry of insects into the entrapment chamber. Note that when the entrapment chamber is open, the connection ring 510 is at the bottom of the exposed component 501 next to the cone component 520.

FIGS. 6A1-6A3 and 6B1-6B3 are a variety of perspective views of an embodiment of the entry port with the landing surface for the insect trap of FIG. 1 while the trap is closed (FIGS. 6A1-6A3) and while the trap is open (FIGS. 6B1-6B3). FIGS. 6A1-6A3 and 6B1-6B3 do not show the entrapment chamber (e.g., bag) in order to show the configuration of the exposed component 601 and the cone component 620 from different angles. FIGS. 6A1-6A3 show the entry port closed and FIGS. 6B1-6B3 show the entry port open. The entry port of the insect trap 600 may include exposed component 601, connection ring 610, cone component 620, cone receptacle 621, cone rim 622, and fins 675a-n. In other embodiments insect trap 600 may not have all of the elements or features listed and/or may have other elements or features instead of or in addition to those listed. The insect trap 600 may include all of the components discussed in FIGS. 1-5. In other embodiments, insect trap 600 may not have all of the elements or features listed and/or may have other elements or features instead of or in addition to those listed.

Exposed component 601, connection ring 610, cone component 620, cone receptacle 621, cone rim 622, and fins 675a-n are embodiments of exposed component 301, connection ring 310, cone component 320, cone receptacle 321, cone rim 322, and fins 375a-n, respectively, which have been discussed with reference to FIG. 3. Other aspects of each part of the insect trap have been discussed in other figures.

FIGS. 6A1-6A3 and 6B1-6B3 show three perspective views of the trap entry components previously disclosed with the additional landing pad 630 having the exterior perimeter of a flower.

In FIGS. 6A1-6A3, the components are in the closed position and insects cannot enter the entrapment chamber. Note that when the entrapment chamber is closed, the connection ring 610 and landing pad 630 are at the top of the exposed component 601 away from the cone component 620.

In FIGS. 6B1-6B3, the components are in the open position in which insects may enter the entrapment chamber. The landing pad 630 can be attached to the part that moves away from the entrapment chamber during opening (the attachment ring 610). Note that when the entrapment chamber is open, the connection ring 610 and landing pad 630 are at the bottom of the exposed component 601 next to the cone component 620.

### The Attractant

The attractant or attractant may include one or more attractants that attract any insect. The attractant may be chosen based on the type of insect or insects to be attracted. For example, the insect attractant may be a pheromone, kairomone, food attractant, fragrance, and/or mixtures therein.

Advantages of using insect pheromones as attractants are that, unlike conventional pesticides, insect pheromones do not damage other animals, nor do they pose health risks to people. Pheromones may specifically disrupt the reproductive cycle of harmful insects. The pheromones may be any type of pheromone, including but not limited to, a sex pheromone, an aggregation pheromone, a trail pheromone, an alarm pheromone, a kairomone, swarming attractants, feeding attractants, a male-produced pheromone or a female-produced pheromone. Known sex pheromones include but are not limited to, cis-9-dodecen-1-yl acetate, cis-7-dodecen-1-yl acetate and trans-8, trans-10-dodecadien-1-ol. The attractants may be effective by themselves, or their attractiveness may be increased by adding a synergist. For example for cis-9-dodecen-1-yl acetate a synergist is Z11-tetradecen-1-yl acetate (Endopiza viteana). For cis-7-dodecen-1yl acetate both cis-9-dodecen-1-yl acetate and cis-11-hexadecen-1-yl acetate are synergists (Agrotis ipsilon) and for trans-8, trans-10-dodecadien-1-ol a synergist is trans-8, trans-10-dodecadien-1-yl acetate (Cydia pomonella).

The attractant may be an amount of the attractant spotted or otherwise placed onto a portion of the trap (e.g., the entrapment chamber) and/or on a material (matrix) attached to the trap in an area inside the trap. In at least one embodiment, the attractant is initially contained within a matrix to affect slow release. The attractant may be placed within the matrix by absorption. A matrix is any substance that will reversibly adsorb the attractant. Examples of common matrices that reversibly adsorb insect attractants are polar and non-polar polymers such as polyvinyl chlorides, polyvinyl acetates, polyurethanes, polyamides, polyesters and polyhydrocarbons (polyethylene, polybutadiene). Zeolites, clays, and related inorganic materials also function well as reversible adsorbers of insect attractants. Natural and synthetic fibers such as wood, cotton, cellulose acetate and spun fiber plastics serve well as reversible adsorbers of insect attractants. A unique absorbent is electrostatically charged wax which will adhere to the bodies of arriving insects. When electrostatically charged wax is used no adhesive need be used in the trap and the insect would escape to act as a discrete mobile attractant luring other insects toward the electrostatically charged wax in unproductive mating or foraging activity

In at least one embodiment, the attractant is enclosed in a semi-permeable membrane to effect slow-release of the attractant. In at least one embodiment, a semi-permeable membrane allows for movement of attractant molecules through the membrane. In an embodiment, a semi-permeable membrane may be chosen such that attractants permeate through the membrane. Any molecule with a vapor pressure that allows evaporation at room temperature will permeate through a plastic membrane as long as the membrane has a polarity similar to that of the attractant molecule. That is, non-polar attractants with significant vapor pressure at room temperature permeate through non-polar membranes, such as polyhydrocarbons, while polar attractants with significant vapor pressure at room temperature permeate through polar membranes, such as polyamides. Semipermeable membranes may be purchased from The Dow Chemical Company, 2030 Dow Center, Midland, Mich. 48674.

In at least one embodiment, the attractant is shipped and stored in a sealed package made of an impermeable membrane. Impermeable membranes are those that contain films of impermeable materials such as aluminum.

In at least one embodiment, the attractant includes an insecticide that kills the insect when the insect touches the trap.

### Insect-Retaining Adhesive

A trap may have a sticky substance (an insect-retaining adhesive) that retains the insect when the insect touches one or more parts of the trap. The insect-retaining adhesive may be any adhesive that retains insects, including but not limited to, a glue, a sticky substance, wax, oils, oil mixtures, polyisobutene resins, detergents (e.g., laundry) and mixtures thereof

While, it may be that the insect retaining adhesive may be applied to any part of the trap, it would not be practical to apply the adhesive to areas that might be contacted by fingers, such as any part of the trap that would be contacted to set up the trap. In at least one embodiment, the insect-retaining adhesive is applied to the inside of the trap. Applying the insect retaining adhesive to the inside of the trap may include applying the insect retaining adhesive to the cone, the entrapment chamber or some other part of the trap that is not exposed to the outside. In an embodiment, using the adhesive the entrapment chamber is made from a rigid material, so that the walls do not stick together as a result of the adhesive. The insect-retaining adhesive may hang in the middle of the entrapment chamber. In at least one embodiment, insect-retaining adhesive is not applied to the cone because insects may stick and block the entrance to the entrapment chamber. The insect-retaining adhesive may be applied to any portion of the surface and/or surfaces, but in at least one embodiment, the insect-retaining adhesive is applied to approximately the entire surface of the inside of the trap. In at least one embodiment, the adhesive is not applied to the entrapment chamber (e.g., bag) because the adhesive may cause the bag to stick together. In at least one embodiment, the insect-retaining adhesive does not allow for the irreversible adhesion of one part (or piece) of the trap to another part or piece of the trap. An example of a suitable insect adhesive is Stickem™ which is produced by Seabright Laboratories, 4026 Harlan Street, Emeryville, Calif. 94608-3604.

In at least one embodiment, the insect-retaining adhesive includes an insecticide that kills the insect when the insect touches the trap. In at least one embodiment, the insect-retaining adhesive contains an attractant. In at least one embodiment, the attractant is a sweet, non toxic fluid (e.g., apple juice), and the insects die as a result of not being able to figure out how to leave the entrapment chamber.

### Packaging

The traps may be packaged in a protective wrap, such as a plastic wrap for shipping and/or storage. The protective wrap may act to keep the attractant from escaping before use. The traps may be generally packaged or wrapped individually but may also be wrapped in groups on two or more. Thus, if a user wants to place two traps in the same place, a package of two may be removed. The removal may act to release an attractant.

The ability of the entry ports of the traps to be closed allows the trap to be shipped and stored in a locked closed position for shipment and storage and then opened for use and locked closed for disposal. The ability of the top to lock closed to an entrapment chamber allows attractive baits activated by moisture to be enclosed in the entrapment chamber at the point of manufacture. During shipment and storage the bait in the entrapment chamber is protected from moisture by the closed top and the entrapment chamber enclosure. When the trap top is opened by the user, which occurs by a twisting action of the trap top with respect to the remainder of the trap, additional additives required for the activity of an attractant bait may be added (e.g., water). Additionally, the ability of the top to lock onto an entrapment chamber, allows the top to be locked closed for disposal after use and when the trap contains bacteria ridden and dangerous insects.

### Examples

FIGS. 7-12 provide examples showing that when insect traps are fabricated with either multicolored trap tops (e.g., the exposed component), multicolored entrapment chambers or flower shaped landing surfaces near the entry port of the trap, increased numbers of house flies and yellowjackets are captured in the trap. Therefore, any of multicolored trap tops, multicolored entrapment chambers or flower shaped landing surfaces near the entry port, when added to the design of insect traps, improves the performance of the traps. While flies and yellowjackets were used in the examples, the results can be extrapolated to any type of insect that may be captured using this type of insect trap. Thus, the results may be extrapolated to any type of insect that exhibits the same behavior as the housefly and/or yellowjackets. Houseflies and yellowjackets fly to the area of a trap and then land on the trap to which the insect is attracted. After landing, the housefly and/or yellowjacket crawls into the trap. The behavior of landing on a portion of the trap is contrasted with that of insects such as bark beetles that fly to a trap, strike part of the trap and then drop into the trap.

FIGS. 7 and 8 provide data showing that the addition of a landing pad 130 (in FIG. 1), which was a ring resembling a flower shape, to the entry port 101 (in FIG. 1) significantly increased capture of insects.

FIG. 7 provides a figure showing the effect of landing surface shapes (e.g., rings) on capture of the common housefly (Musca domestica) as compared to a control with no landing surface (e.g., ring). In FIG. 7, an experiment was conducted comparing traps that were identical in all structural aspects except for the shape of the landing ring surface that surrounded the entry components.

The experiment compared the capture of houseflies in traps that were identical except for the landing ring surface (see landing pad 130 in FIG. 1). The traps emitted vapors from fermenting sugar and eggs, which are known housefly attractants. The traps all contained the exposed component 101 (in FIG. 1), the connection ring 110 (in FIG. 1) and the cone component (120 in FIG. 1). Additionally, a rectangular landing surface, a circular landing surface, and a landing surface that had an irregular outer edge resembling the shape of a flower (e.g., component 130 in FIG. 1) were attached to the connection ring 110 of different traps. The results in FIG. 7 showed that significantly more house flies were captured in traps with a landing ring surface that had an irregular exterior edge resembling the shape of a flower (e.g., landing pad 130) than were captured in traps with landing surfaces of other shapes.

Traps with and without landing surfaces surrounding the entry port were compared for capture of Musca domestica in a cow barn during a 7 day period. One trap design contained no landing surface. A second trap design contained a translucent square. A third trap design contained a landing surface with a circular outer edge and a fourth trap design contained a landing ring surface that had an irregular exterior edge resembling the shape of a flower (e.g., landing pad130 in FIG. 1). The landing surfaces were translucent plastic with identical surface areas. For this test the tops of the entry ports of all traps were black (e.g., exposed component 101 in FIG. 1) and the connection rings (e.g., component 110 in FIG. 1) of all traps were black. The attractant in all traps was 1 gram of Baker's yeast, 1 gram sugar, 1 gram of powdered eggs and 200 milliliters of water. The traps were hung 3 meters apart and 1.5 meters above ground. The positions of the traps were re-randomized daily. Different letters above bars in FIG. 7 signify captures that are significantly different to confidence level of 95% by Bonferroni comparison (SYSTAT 13). The data show that the translucent ring with indentations (flower-likes shape) attracted significantly more flies than the translucent ring with no indentations and no ring. However, the translucent ring with no indentations did attract more flies than the trap with no ring/landing surface.

FIG. 8 provides a figure showing the effect of landing surface shapes (e.g., rings) on capture of yellowjackets as compared to a control with no ring. In FIG. 8 an experiment was conducted comparing traps that were identical in all structural aspects except for the shape of the landing ring surface that surrounded the entry components.

The experiment compared the capture of yellowjackets in traps that were identical except for the landing ring surface (see landing pad 130 in FIG. 1). These traps emitted heptyl butyrate, a known yellowjacket attractant, and contained soapy water, a known retention liquid (insect-retaining adhesive) for yellowjackets. The traps all contained the entry port 101 (in FIG. 1), the connection ring 110 (in FIG. 1) and the cone component 120 (in FIG. 1). A rectangular landing surface, a circular landing surface and a landing surface that had an irregular outer edge resembling the shape of a flower (e.g., component 130 in FIG. 1) were attached to the connection rings (e.g., component 110 in FIG. 1) of different traps.

In a little more detail, the traps were compared for capture of yellowjackets in a public park over a 7 day period in August. One trap design contained no landing surface. A second trap design contained a translucent square. A third trap design contained a landing surface with a circular outer edge and a fourth trap design contained a landing ring surface that had an irregular exterior edge resembling the shape of a flower (e.g., component 130 in FIG. 1). The landing surfaces were translucent plastic with identical surface areas. For this test, the tops of the entry ports (e.g., exposed portion 101 in FIG. 1) of all traps were black and the connection rings (e.g., connection ring component 110 in FIG. 1) of all traps were black. The attractant in all traps was a slow release formulation that released heptyl butyrate at the rate of 20 mg/day. Each trap contained 200 milliliters of water containing 1% laundry detergent to retain arriving insects (insect-retaining liquid). The traps were hung 3 meters apart and 1.5 meters above ground on a fence. The positions of the traps were re-randomized daily. Different letters above the bars in FIG. 8 signify captures are significantly different to confidence level of 95% by Bonferroni comparison (SYSTAT 13).

The results in FIG. 8 show that significantly more yellowjackets were captured in traps with a landing ring surface that had an irregular exterior edge resembling the shape of a flower (e.g., like that of landing pad 130 in FIG. 1) than were captured in traps with landing surfaces of other shapes.

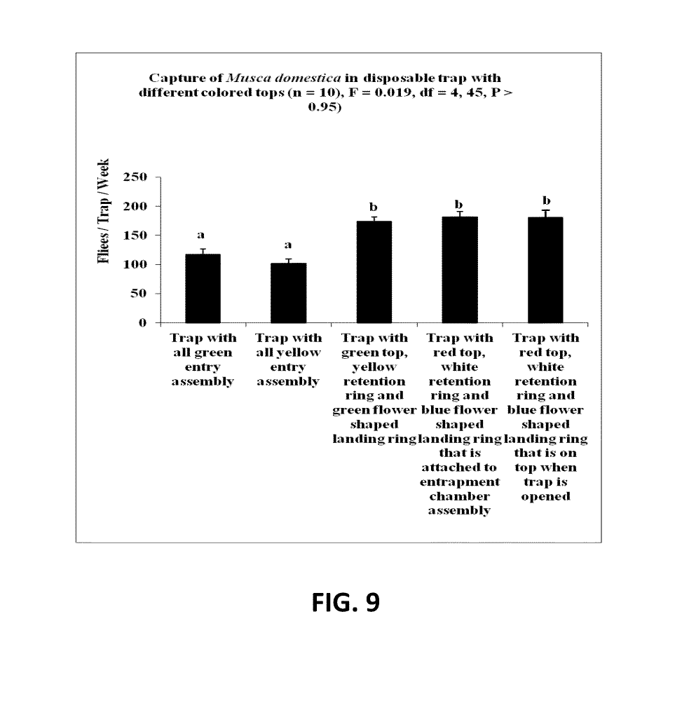

FIG. 9 shows the effect of the color of the top (e.g., entry port) on the capture of the common housefly (Musca domestica) as compared to a control with no color. The experiment compared the capture of houseflies in traps that were identical except for the colors of the top, connection ring and landing ring components. Additionally, FIG. 9 shows the effect of attachment of the landing pad 130 (in FIG. 1) to the components of the trap that are attached to the entrapment chamber versus the attachment of the landing ring to the exposed component (see FIG. 1). Any components of a trap that can be seen by insects could be produced of materials of different colors to attract insects. In this experiment, the top component (e.g., exposed component, 101 in FIG. 1) was fabricated in one color, the connection ring (e.g., connection ring 110 in FIG. 1) was fabricated to have the same or preferably a different color as the exposed component, and the landing ring (e.g., landing pad 130 in FIG. 1) was fabricated to have the same or preferably a different color than either of the entry port and connection ring components.

FIG. 9 contains comparisons between traps that were identical in all structural respects except for the colors of these components. FIG. 9 also contains a comparison of two trap designs in which each design has the same colors of components but in which the landing ring is either attached to the components attached to the entrapment chamber or to the entry port 101 (see 101 in FIG. 1). Thus, FIG. 9 also shows the effect of attaching the landing ring to the portion of the entry port that is attached to the entrapment chamber compared to the effect of attaching the landing ring to the portion of the entry port that rises during opening of the entry port.

Each of the traps emitted vapors from fermenting sugar and eggs, a known housefly attractant. The entry assemblies of the traps compared, contained either all green elements (the top, connection ring and landing ring), all yellow elements (the top, connection ring and landing ring), a green entry port, a yellow connection ring and a green landing ring surface or a red entry port, a white connection ring and a blue landing ring surface. Two designs of the latter multicolored trap were tested in this experiment. One design contained the landing ring attached to the components attached to the entrapment chamber while the other design had the landing ring attached to the exposed component (see exposed component 101 in FIG. 1).

In the experiment, single color or multicolor entry ports and landing rings and landing ring locations were compared for capture of Musca domestica in a cow barn over a 7 day period in late December early January. The traps contained an entry port, connection ring, and landing ring surface of all green or all yellow or a combination of green entry port, yellow connection ring and green landing ring or red entry port, white connection ring and blue landing ring. In the case of the traps containing the multicolored entry port landing rings were located either attached to the connection ring attached to the entrapment chamber or to the entry port (see exposed component 101 in FIG. 1). All landing rings were flower shaped as shown in FIGS. 1, 2, 4 and 6. All entrapment chambers were multicolored flower designs. Attractants in all traps were 1 gram of Baker's yeast, 1 gram of sugar, 1 gram of powdered eggs and 200 milliliters of water. The traps were hung 3 meters apart and 1.5 meters above ground. The positions of the traps were re-randomized daily. Different letters above bars in FIG. 9 signify captures are significantly different to confidence level of 95% by Bonferroni comparison (SYSTAT 13).

The results in FIG. 9 showed that significantly more house flies were captured in traps that contained exposed components that were of different colors. Traps fabricated with exposed component colors that were different from the other component captured significantly more flies than traps in which these three elements were all the same color. Thus, the use of different colors for each of the entry port, connection ring and landing ring of the trap was found to increase the captures of house flies. The different colors may also increase the attractiveness of the visual appearance of the trap to users. Further, the results in FIG. 9 also showed that for traps containing the multicolored entry port, location of the landing ring near the entrapment chamber gave the same attraction as when the landing ring was located on the entry port (see entry port top 101 in FIG. 1).

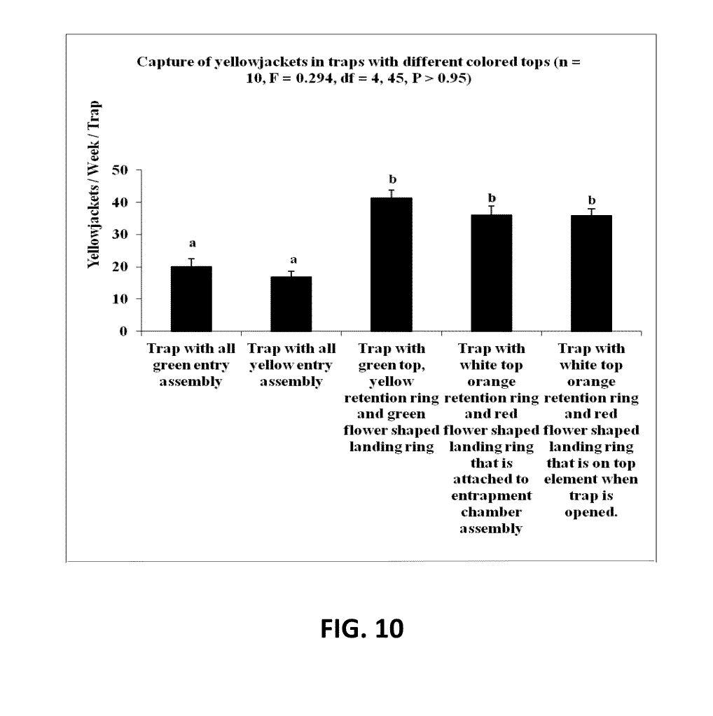

FIG. 10 shows the effect of using different colors for the top (e.g., entry port) components on capture of yellowjackets as compared to a control with only one color. Additionally, FIG. 10 shows the effect of attachment of the landing ring to the components of the trap that are attached to the entrapment chamber versus the attachment of the landing ring (landing pad 130 in FIG. 1) to the top component (exposed component). Thus, FIG. 10 shows the effect of attaching the landing ring to the portion of the entry port that is attached to the entrapment chamber compared to the effect of attaching the landing ring to the portion of the entry port that rises during opening of the entry port.

In the experiment of FIG. 10, the colors of the traps were identical except for the colors of the top (exposed component), connection ring, and landing ring. These traps emitted vapors of heptyl butyrate, a known yellowjacket attractant and contained soapy water, which is known to retain arriving yellowjackets. The entry assemblies of the traps compared, contained either all green components (the top, connection ring and landing ring), all yellow components (the top, connection ring and landing ring), a green entry port, a yellow connection ring and a green landing ring surface or a white entry port, an orange connection ring and a red landing ring. Two trap designs containing the latter color combination were compared. One trap design contained the red landing ring attached to the connection ring which is attached to the entrapment chamber while in the second trap design the red landing ring was attached to the exposed component (101 in FIG. 1) which rises when the trap is opened.

In the experiment, the traps were compared for capture of yellowjackets in a public park in a one week period in August. All landing rings were flower shaped as shown in FIGS. 1, 2, 4, and 6. All entrapment chambers had multicolored flower designs. The attractant in all traps was heptyl butyrate released at 20 mg/day and 200 milliliter of water containing 1% laundry detergent to retain arriving yellowjackets. The traps were hung 3 meters apart at 1.5 meters above ground on a fence. The positions of the traps were re-randomized daily. Different letters above bars in FIG. 10 signify captures are significantly different to confidence level of 95% by Bonferroni comparison (SYSTAT 13).

The results in FIG. 10 show that significantly more yellowjackets were captured in traps that were fabricated to contain top components with colors that were different from each other. Traps with a green entry port, yellow connection ring and green landing ring surface or a white entry port, orange connection ring and red landing ring captured significantly more yellowjackets than traps with all green components or all yellow components. Additionally, traps with a white entry port, orange connection ring and red landing ring captured equivalent numbers of yellowjackets regardless of the location of the landing ring on an element attached to the entrapment chamber or attached to the top of the exposed component 101.

In FIGS. 11 and 12 an experiment was conducted to identify the effect of an entrapment chamber with a flower design on the exterior surface on capture of the common housefly and yellowjackets, respectively.

FIG. 11 provides a figure showing the effect of the design of the color of the entrapment chamber (e.g., bag) on capture of the common housefly (Musca domestica) as compared to controls with no color or patterns of color that are different than flowers. Comparisons were conducted between traps that were identical in all structural respects except for the printed design on the exterior of the entrapment chamber. The area in square centimetres per shade of each color per side for the entrapment chamber is given in Table 1. Each color printed on the entrapment chamber was displayed in a light medium and intense shade. These are represented by Shade 1 Shade 2 and Shade 3 under each color heading in Table 1. The traps emitted vapors from fermenting sugar and eggs. The traps had entrapment chambers that were translucent, entrapment chambers that had multicolored flower designs on the exterior (e.g., FIG. 1), entrapment chambers that possessed squares with the same colors as the entrapment chambers with flower designs, and entrapment chambers with triangles with the same colors as the entrapment chambers with flower designs.

In the experiment, the traps with different designs on the entrapment chambers were compared for capture of Musca domestica in a cow barn over 7 days in early January. All traps were fabricated with yellow tops, red connection rings, and blue landing rings that were flower shaped. Entrapment chambers were plain translucent, flower design, multicolor squares and multicolor triangles. The entrapment chambers with squares and triangles contained the same areas of each shade of each color as the entrapment chambers with the flower designs. The attractant in all traps was 1 gram of Baker's yeast, 1 gram of sugar, 1 gram of powdered eggs and 200 milliliters of water. The traps were hung 3 meters apart and 1.5 meters above ground. The positions of the traps were re-randomized daily. Different letters above bars signify captures are significantly different to confidence level of 95% by Bonferroni comparison (SYSTAT 13).

The results in FIG. 11 show that significantly more house flies were captured in traps that possessed entrapment chambers that had multicolored flower designs on the exterior than in traps with translucent, multicolored squares, or multicolored triangles. Thus, use of an entrapment chamber with a flower design on the exterior was shown to increase the number of house flies captured compared to traps with entrapment chambers that did not have flower designs. In addition, the flower pattern increased the visual appearance of the trap to users.

FIG. 12 provides a figure showing the effect of the design of the color of the entrapment chamber (e.g., bag) on capture of yellowjackets as compared to controls with no color or patterns of color that are different than flowers. The experiment was performed to identify the effect of the color of the entrapment chamber on the capture of yellowjackets. The traps were identical except for the printed design on the exterior of the entrapment chamber. The area in square centimetres per shade of each color per side for the entrapment chamber is given in Table 1. Each color printed on the entrapment chamber was displayed in a light medium and intense shade. These are represented by Shade 1 Shade 2 and Shade 3 under each color heading in Table 1. The traps emitted vapors of heptyl butyrate. The traps had entrapment chambers that were translucent, entrapment chambers that had multicolored flower designs on the exterior, entrapment chambers that had squares with the same colors as the entrapment chambers with flower designs and entrapment chambers with triangles with the same colors as the entrapment chambers with flower designs.

In the experiment, traps with different designs on the entrapment chamber were compared for capture of yellowjackets in a public park over a 7 day period in late August. All traps contained yellow tops, red connection rings, and blue landing rings that were flower shaped. Entrapment chambers were plain translucent, flower design, multicolor squares, and multicolor triangles. The entrapment chambers with squares and triangles that contained the same areas of the same shades of each color as the entrapment chambers with the flower designs. The attractant in all traps was heptyl butyrate and was released at 20 mg/day and 200 milliliter water with 1% laundry detergent was included to retain arriving yellowjackets. The traps were hung 3 meters apart and 1.5 meters above the ground on a fence. The positions of traps were re-randomized daily. Different letters above the bars in FIG. 12 signify captures are significantly different to confidence level of 95% by Bonferroni comparison (SYSTAT 13).

The results in FIG. 12 showed that significantly more yellowjackets were captured in traps that possessed entrapment chambers with multicolored flower designs on the exterior than in traps with translucent, multicolored squares or multicolored triangles. Thus, use of an entrapment chamber with a flower design on the exterior was shown to increase the number of yellowjackets captured compared to traps with entrapment chambers that did not have flower designs. In addition, the flower pattern increased the visual appearance of the trap to users.

TABLE 1
Color distribution on entrapment chamber.
(Ocean Optics reflectance spectrometer 2000)

| Color | | | | | | |
|---|---|---|---|---|---|---|
| parameter | Flower color | | | | | |
| | Purple | | | Pink | | |
| | Shade | Shade | Shade | Shade | Shade | Shade |
| | 1 | 2 | 3 | 1 | 2 | 3 |
| CIE L* | 19.6 | 31.1 | 26.4 | 51.3 | 48.3 | 41.3 |
| CIE a* | 13 | 11.8 | 13 | 46.4 | 50.2 | 34.3 |
| CIE b* | −24.4 | −22.8 | −26 | 2.4 | 2.7 | 2.2 |
| Area | 6.7 | 9.1 | 4.5 | 5.5 | 6.6 | 5.9 |
| (cm²/Side | | | | | | |
| | Orange | | | Light blue | | |
| | Shade | Shade | Shade | Shade | Shade | Shade |
| | 1 | 2 | 3 | 1 | 2 | 3 |
| CIE L* | 52 | 53.9 | 58.3 | 49.8 | 45.3 | 36.8 |
| CIE a* | 39.8 | 37 | 29.1 | −25.2 | −30.3 | −34.3 |
| CIE b* | 75.1 | 64.2 | 48.3 | −14.2 | −18.8 | −18.9 |
| Area | 8 | 8 | 4 | 3.9 | 2.9 | 6.3 |
| (cm²/Side | | | | | | |
| | Green | | | Yellow | | |
| | Shade | Shade | Shade | Shade | Shade | Shade |
| | 1 | 2 | 3 | 1 | 2 | 3 |
| CIE L* | 46.9 | 44.7 | 51.5 | 73.6 | 70.4 | 65.3 |
| CIE a* | −24.3 | −27.2 | −22.1 | −0.2 | −0.4 | 0.5 |
| CIE b* | 37.4 | 48.1 | 30.5 | 70.1 | 44.8 | 90.3 |
| Area | 5.7 | 2.5 | 3.5 | 8.2 | 4.4 | 5.8 |
| (cm²/Side | | | | | | |
| | Red | | | Flower Center | | |
| | Shade | Shade | Shade | | Shade | |
| | 1 | 2 | 3 | | 1 | |
| CIE L* | 45.3 | 38.6 | 45.3 | | 49.7 | |
| CIE a* | 43.9 | 50.6 | 38.6 | | 21 | |
| CIE b* | 38.1 | 50.6 | 34.8 | | 63.5 | |
| Area | 5.8 | 7.6 | 2 | | 13.1 | |
| (cm²/Side | | | | | | |

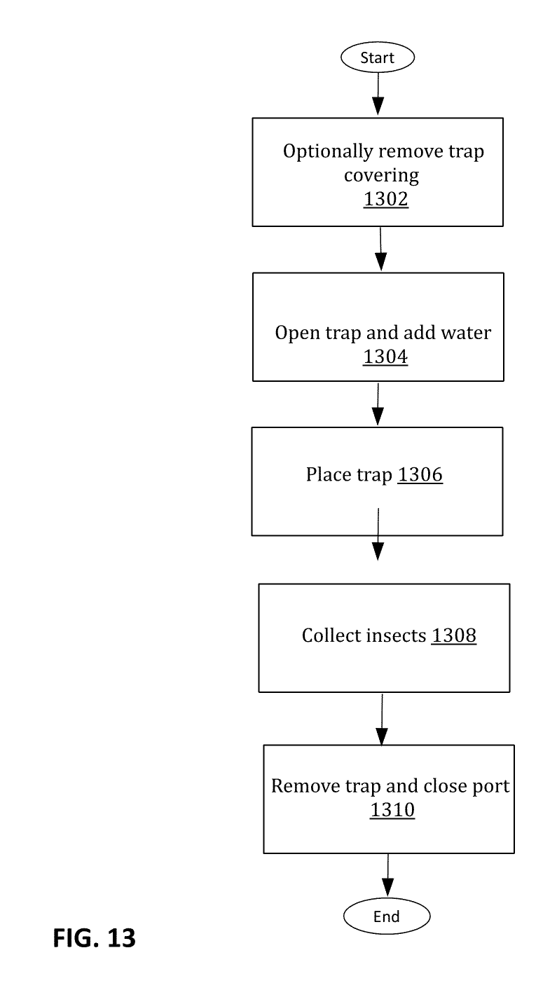

FIG. 13 shows a flowchart of an embodiment of a method of using the insect trap shown in FIGS. 1-6.

In step 1302, the user optionally removes the trap covering. The trap covering can encloses the trap in a protective covering. This protects the trap and keeps the attractant from being lost upon storage and/or transport. The trap covering can be a plastic covering that is sealed. See the section entitled “packaging” for more information on types of trap covers.

In step 1304 the user opens the trap and adds water. The user opens the trap by twisting the top component to the right or left and lifting. Opening the entry component allows insects to enter the trap (e.g., deploys the trap). The water acts to retain arriving insects. Alternatively or additionally, the water may include an attractant.

In step 1306 the user positions the trap. The trap may be placed in any area that contains insects. The trap may be placed using a hanging device which could be a wire or string placed through the hole in the (see entry port 101 in FIG. 1).

In step 1308, the user leaves the trap until the trap collects insects. The user may check the trap periodically to see if the trap has collected insects. The time necessary to trap insects can depend on the time of year, the place where the trap is tested (e.g., a forest compared to a city), etc.

In step 1310, the user removes the trap and closes the port. The port may be closed using the method discussed in FIG. 2.

In further steps, the user may optionally, throw the trap away, remove the entrapment chamber and replace the used entrapment chamber with a new one, reset the trap, and/or set the trap in a different environment.

In an embodiment, each of the steps of method 1300 is a distinct step. In another embodiment, although depicted as distinct steps in FIG. 13, step 1302-1310 may not be distinct steps. In other embodiments, method 1300 may not have all of the above steps and/or may have other steps in addition to or instead of those listed above. The steps of method 1300 may be performed in another order. Subsets of the steps listed above as part of method 1300 may be used to form their own method.

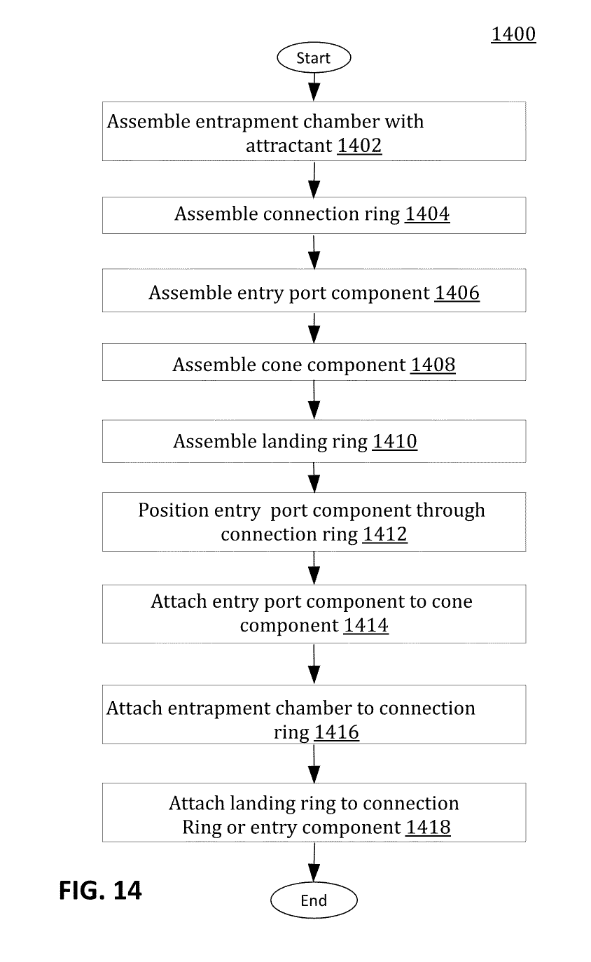

FIG. 14 shows a flowchart of an embodiment of making the trap shown in FIGS. 1-6.

In step 1402, the entrapment chamber is assembled. The entrapment chamber may optionally be assembled with an attractant inside the entrapment chamber (see section entitled “attractant”). The entrapment chamber may be assembled with an insect-retaining adhesive (see section entitled “insect-retaining adhesive”). The entrapment chamber may be constructed in a way that allows for surrounding the cone component and leaving room for insects. The entrapment chamber may be composed of any material that allows for expandability, but is rigid enough to maintain an open shape. The entrapment chamber may be decorated with a floral pattern to increase attractiveness to the insects.

In step 1404, the connection ring is assembled. The connection ring may be constructed of the same or different materials as those used for the entry component and the cone component. In at least one embodiment, the exposed component, the connection ring and the cone component are composed of the same material. In at least one embodiment, the material is a biodegradable material that allows for less environmental impact. In at least one embodiment, the material is a plastic that meets the current ASTM D6400 standard. Any plastic that has the property of thermal deformation or is able to be molded by injection molding and meets the ASTM D6400 standard is suitable for fabrication of the parts of the trap. In at least one embodiment, the connection ring is composed of a material that is a different color from the cone component and/or the top component. In at least one embodiment, the connection ring is composed of a reusable and/or sterilizable material.

In step 1406, the entry component is assembled (the top component). The entry component may be constructed of the same or different materials as the materials used for the connection ring and the cone component. In at least one embodiment, the exposed component, the connection ring component and the cone component are composed of the same material. In at least one embodiment, the material is a biodegradable material that allows for less environmental impact. In at least one embodiment, the material is a plastic that meets the current ASTM D6400 standard. Any plastic that has the property of thermal deformation or is able to be molded by injection molding and meets the ASTM D6400 standard is suitable for fabrication of the parts of the trap. In at least one embodiment, the exposed component is composed of a material that is a different color from the cone component and/or the connection ring. In at least one embodiment, the exposed component is composed of a reusable and/or sterilizable material.

In step 1408, the cone component is assembled. The cone component may be constructed of the same or different materials as those used for the entry component and the connection ring. In at least one embodiment, the exposed component, the connection ring, and the cone component are composed of the same material. In at least one embodiment, the material is a biodegradable material that allows for less environmental impact. In at least one embodiment, the material is a plastic that meets the current ASTM D6400 standard. Any plastic that has the property of thermal deformation or is able to be molded by injection molding and meets the ASTM D6400 standard is suitable for fabrication of the parts of the trap. In at least one embodiment, the cone component is composed of a material that is a different color from the connection ring and/or the top component. In at least one embodiment, the cone component is composed of a reusable and/or sterilizable material.

In step 1410 the landing ring component may be constructed of the same or different materials as those used for the entry component, cone component and the connection ring. In at least one embodiment, the landing ring, the top component, the entry component, and the cone component are composed of the same material. In at least one embodiment, the material is a biodegradable material that allows for less environmental impact. In at least one embodiment, the material is a plastic that meets the current ASTM D6400 standard. Any plastic that has the property of thermal deformation or is able to be molded by injection molding and meets the ASTM D6400 standard is suitable for fabrication of the parts of the trap. In at least one embodiment, the cone component is composed of a material that is a different color from the connection ring and/or the top and/or cone. In at least one embodiment, the landing ring is composed of a reusable and/or sterilizable material.

In step 1412 the entry component (e.g., the top component) is positioned in the center of the connection ring and the cone component is attached to the entry component.

In step 1414 the entry (e.g., top) component and cone component are joined using the snap mechanism described in FIG. 4.

In step 1416 the entrapment chamber and the connection ring are joined.

In step 1418 the landing ring is attached to either the connection ring or the entry component. In at least one embodiment, the landing ring and the connection ring are formed together. In at least one embodiment, the entry port and the landing ring are formed together. In at least one embodiment, the entry port and the connection ring are formed together.

In steps 1416-1418, the parts of the trap may be attached using any means known in the art, including but not limited to, adhesives, staples, heat, etc. Some parts of the trap may be removably attached, while other parts are more permanently attached. This may be accomplished using different methods of attachment and/or different levels of attachment, e.g., adhesives having different strengths.

In at least one embodiment, a trap covering is optionally added that encloses the trap in a protective covering (see section entitled “packaging”). This protects the trap and keeps the attractant and/or insect retaining adhesive from being lost upon storage and/or transport.

In at least one embodiment, an attractant is added within or on the entry port, the entrapment chamber and/or the cone. The attractant may be any type of attractant discussed herein (see also “The Attractant”). An adhesive may also be applied within or on the entry port, the entrapment chamber and/or the cone. The adhesive may be admixed with the attractant or may be separate from the attractant or both (see also “Insect-retaining adhesive”).

The method may also include attaching a hanging device and/or attaching a tag for writing on the device. The method may also include writing instructions and/or labels indicating what different parts of the device are directly on the device. The method may also include providing separate instructions and/or explanations of the device, attractant and/or adhesive, within the packaging and/or attached to the device.

The method may also include attaching a landing ring to the device that resembles the shape of a flower part. The landing ring may have an irregular edge that resembles a flower (e.g., the petals, the sepals, the anthers, the leaves, etc.).

In an embodiment, each of the steps of method 1400 is a distinct step. In another embodiment, although depicted as distinct steps in FIG. 14, step 1402-1414 may not be distinct steps. In other embodiments, method 1400 may not have all of the above steps and/or may have other steps in addition to or instead of those listed above. The steps of method 1400 may be performed in another order. Subsets of the steps listed above as part of method 1400 may be used to form their own method.

Each embodiment disclosed herein may be used or otherwise combined with any of the other embodiments disclosed. Any element of any embodiment may be used in any embodiment.

Although the invention has been described with reference to specific embodiments and examples, it will be understood by those skilled in the art that various changes may be made and equivalents may be substituted for elements thereof without departing from the true spirit and scope of the invention. In addition, modifications may be made without departing from the essential teachings of the invention.

1. A device, comprising:
an entrapment chamber for trapping one or more insects;
an entry port attached to an opening in the entrapment chamber; and
a landing pad having a shape that resembles a portion of a plant; the landing pad being coupled to the entry port, leading insects into the entry port.

2. The device of claim 1 wherein the landing pad is attached to a top portion of the entry port of the trap.

3. The device of claim 1, wherein the entrapment chamber has a plant pattern imprinted on the entrapment chamber, and wherein the plant pattern is more than one color.

4. The device of claim 3, wherein the plant pattern imprinted on the entrapment chamber includes at least one or more flowers.

5. The device of claim 1, wherein the shape of the landing pad includes at least a circular series of petals.

6. The device of claim 1, wherein the shape of the landing pad resembles flower.

7. The insect trapping device of claim 1, wherein the entry port is of a size large enough to allow one or more insects to enter the entrapment chamber, but small enough so that the insects are unlikely to leave the entrapment chamber.

8. The device of claim 1, further comprising an adhesive located within the entrapment chamber.

9. The insect trapping device of claim 1, further comprising an attractant located inside of the entrapment chamber.

10. The insect trapping device of claim 1, wherein the landing pad has an attractant placed on the landing pad.

11. The insect trapping device of claim 1, wherein the entrapment chamber is biodegradable.

12. The insect trapping device of claim 1, wherein the entry port is closable.

13. An entry port for an insect trapping device having a bag for containing one or more insects, comprising;
a landing ring;
an entry component;
a cone component extending into a bag opening, the landing ring surrounding the cone component;
a connection ring including at least one or more tabs extending downwards, and
a rim extending from the cone component at its dimension of largest diameter, said rim attaching the cone component to the connection ring,
wherein said tabs are flexible enough to allow the rim to pass upward to contact the connection ring and once the rim touches the tabs move towards each other and the upper sides of tabs touch the lower sides of the outer portion of rim to lock rim against connection ring to close the entry component.

14. The entry port of claim 13, wherein the connection ring and the cone component may lock stably against each other closing the opening.

15. The entry port of claim 13, wherein a clip mechanism holds the entry component and cone together.

16. A method of trapping insects, comprising:
obtaining the insect trapping device of claim 1;
placing the trapping device of claim 1 in a location for an amount of time necessary to collect insects; and
removing the trap.

17. The method of claim 16, further comprising closing the entry port of the insect trapping device.

18. A device comprising:
an entrapment bag for trapping one or more insects, the entrapment bag having a flowered or multicolored design on the outside of the entrapment bag, the entrapment bag having an opening;
an entry port attached to the entrapment bag; and
a landing ring coupled to the entry port, the landing port having an irregular outer edge, the landing ring having a shape resembling a ring of pedals.
